(19) United States
(12) Patent Application Publication
(10) Pub. No.: US 2026/0178627 A1
(43) Pub. Date: Jun. 25, 2026

(54) METHODS, APPARATUSES AND COMPUTER PROGRAM PRODUCTS FOR AN ARTIFICIAL INTELLIGENCE CHARACTER INTERACTION MODEL

(71) Applicant: Meta Platforms, Inc., Menlo Park, CA (US)

(72) Inventors: Leif Haven Martinson, Oakland, CA (US); RK Parthasarathy, Palo Alto, CA (US); Jessica Thierman, San Francisco, CA (US)

(21) Appl. No.: 19/426,019

(22) Filed: Dec. 18, 2025

Related U.S. Application Data
(60) Provisional application No. 63/737,487, filed on Dec. 20, 2024.

(51) Int. Cl. G06F 16/3329; G02B 27/01; G10L 15/22

(52) U.S. Cl. CPC G06F 16/33295; G02B 27/017; G10L 15/22

(57) ABSTRACT

A system and method for facilitation of AI character based user engagement is provided. The system may detect an input of a user. The system may further analyze the input of the user to determine and select, from among a plurality of artificial intelligence characters having distinctive character personalities, an AI character including a personality associated with an indication of the input of the user. The system may further generate a response to the input of the user based on the personality of the AI character. The system may further present the generated response to the communication device of the user in a context associated with the personality of the AI character.

### CROSS-REFERENCE TO RELATED APPLICATIONS

This application claims priority to U.S. Provisional Application No. 63/737,487, filed Dec. 20, 2024, entitled “Artificial Intelligence Character Interaction Model,” which is incorporated by reference herein in its entirety.

### TECHNOLOGICAL FIELD

Examples of the present disclosure may relate generally to methods, apparatuses and computer program products for facilitating character interactions via artificial intelligence technologies.

### BACKGROUND

The advancement of Generative AI technology has led to increased user interest in various methods and formats of interacting with the technology. Interacting with AI characters may provide enormous potential in adding entertainment and specialty use cases. AI characters may offer interest, entertainment, and excitement to users, especially on interfaces that are heavily reliant on text-to-speech (TTS) functionalities. However, developing and integrating interactive characters and/or personalities into wearable devices, such as smart glasses, presents a unique challenge that has not yet been fully addressed in the industry.

### BRIEF SUMMARY

Aspects of the present disclosure pertain to the development and implementation of AI Character model architecture designed to enhance user interactions across multiple platforms, including augmented reality (AR), virtual reality (VR), and mixed reality (MR) environments. These AI Characters may be accessed directly through unique wake words or indirectly via a multi-turn conversational session with an AI assistant, thereby providing a versatile and engaging user experience. The following sections detail the technical specifications of the AI Character model architecture, numerous examples of use cases, and different interaction methods.

Aspects of the present disclosure may include systems and methods for facilitating character-based user engagement on various platforms, such as artificial intelligence, virtual reality, and mixed reality devices. Aspects may receive user input at a user device, and process user input to identify an intended character. A conversational session with the intended character may be initiated and operated using a character component. One or more responses to a user query or statement may be made based on the intended character's trained persona. The generated response may be converted to audio output using a text-to-speech (TTS) engine. In additional examples, the user device includes at least one of a headset, smartphone, tablet, laptop, or gaming console. In examples, processing the user input may include recognizing dynamic wake words to initiate interactions with an AI Assistant component or the character component.

In one example of the present disclosure, a method is provided. The method may include detecting, by a communication device, an input of a user. The method may further include analyzing the input of the user to determine and select, from among a plurality of artificial intelligence characters comprising distinctive character personalities, an artificial intelligence character comprising a personality associated with an indication of the input of the user. The method may further include generating a response to the input of the user based on the personality of the artificial intelligence character. The method may further include presenting the generated response to the communication device of the user in a context associated with the personality of the artificial intelligence character.

In another example of the present disclosure, an apparatus is provided. The apparatus may include one or more processors and a memory including computer program code instructions. The memory and computer program code instructions are configured to, with at least one of the processors, cause the apparatus to at least perform operations including detecting, by the apparatus, an input of a user. The memory and computer program code are also configured to, with the processor(s), cause the apparatus to analyze the input of the user to determine and select, from among a plurality of artificial intelligence characters comprising different character personalities, an artificial intelligence character comprising a personality associated with an indication of the input of the user. The memory and computer program code are also configured to, with the processor(s), cause the apparatus to generate a response to the input of the user based on the personality of the artificial intelligence character. The memory and computer program code are also configured to, with the processor(s), cause the apparatus to present the generated response to a communication device of the user in a context associated with the personality of the artificial intelligence character.

In yet another example of the present disclosure, a computer program product is provided. The computer program product may include at least one non-transitory computer-readable medium including computer-executable program code instructions stored therein. The computer-executable program code instructions may include program code instructions configured to detect, by a communication device, an input of a user. The computer program product may further include program code instructions configured to analyze the input of the user to determine and select, from among a plurality of artificial intelligence characters comprising distinctive character personalities, an artificial intelligence character comprising a personality associated with an indication of the input of the user. The computer program product may further include program code instructions configured to generate a response to the input of the user based on the personality of the artificial intelligence character. The computer program product may further include program code instructions configured to present the generated response to the communication device of the user in a context associated with the personality of the artificial intelligence character.

In one example aspect of the present disclosure, a method is provided. The method may include receiving user input at a user device, processing the user input to identify an intended character, initiating a conversational session with the intended character using a character component, generating a response, by the character component, based on the intended character's trained persona, and converting the generated response to audio output using a Text-to-Speech (TTS) engine.

In another example aspect of the present disclosure, an apparatus is provided. The apparatus may include one or more processors and a memory including computer program code instructions. The memory and computer program code instructions are configured to, with at least one of the processors, cause the apparatus to at least perform operations including receiving user input at a user device, processing the user input to identify an intended character, initiating a conversational session with the intended character using a character component, generating a response, by the character component, based on the intended character's trained persona, and converting the generated response to audio output using a Text-to-Speech (TTS) engine.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the present disclosure; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4 illustrates an example to invoke a character model in accordance with various aspects of the present disclosure.

FIG. 5 illustrates an example to dismiss a character model architecture in accordance with various aspects of the present disclosure.

FIG. 6A illustrates an example for talking with a character model in accordance with various aspects of the present disclosure.

FIGS. 6B, 6C, 6D and 6E illustrate numerous examples of a user interaction(s) with one or more AI Characters in accordance with various aspects of the present disclosure.

FIG. 7 illustrates an example operational flow in accordance with various aspects of the present disclosure.

FIG. 8 illustrates an example of a machine learning framework in accordance with one or more examples of the present disclosure.

FIG. 9 illustrates a head mounted display, in accordance with various aspects discussed herein.

FIG. 10 illustrates an artificial reality system comprising a headset, in accordance with an example of the present disclosure.

FIGS. 11 and 12 illustrate content presented by a display of a head-mounted display in response to user interactions with an AI Character(s) in accordance with examples of the present disclosure.

FIG. 13 illustrates an example flowchart illustrating operations of a process in accordance with an example of the present disclosure.

The figures depict numerous examples for purposes of illustration only. One skilled in the art will readily recognize from the following discussion that alternative examples of the structures and methods illustrated herein may be employed without departing from the principles described herein.

### DETAILED DESCRIPTION

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claimed subject matter.

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, AI character(s) may refer to an artificial intelligence-based entity designed to interact with users through various digital interfaces. An AI Character(s) may possess one or more of a unique personality, knowledge base, and TTS voice, enabling the AI Character(s) to engage in personalized, context-aware conversations. In some examples, these AI Characters may be integrated across multiple platforms, including augmented reality (AR), virtual reality (VR), and/or mixed reality (MR) environments, enhancing user experience through immersive and interactive engagements. AI Characters may be fine-tuned (e.g., trained and/or prompted) to perform a variety of functions, such as providing information, entertainment, assistance, and more, adapting their responses based on user input(s) and/or contextual data.

As referred to herein, “prompting,” “prompted,” or the like may refer to generating one or more inputs and/or instructions for provision to a machine learning (ML) model and/or artificial intelligence (e.g., a large language model(s) (LLMs)), to trigger the machine learning model and/or AI to generate one or more outputs.

As referred to herein, an AI Character persona, and/or an AI Character personality may be an AI agent persona, or an AI chatbot persona, having a defined/designated personality, behavior(s), trait(s), voice, tone and/or style of a character to facilitate user interactions for a tailored and/or personalized user experience. The AI Character persona/personality may guide the manner in which the AI Character speaks and interacts with users.

As referred to herein, a wake word(s) may be a word(s) and/or a phrase(s) that triggers an AI Character, AI agent, AI chatbot, virtual assistant, voice assistant, or the like to begin actively processing commands (e.g., voice commands) to interact with a user (e.g., engage in conversation with a user). In this regard, a wake word(s) may serve as a trigger to inform the AI Character, AI agent, AI chatbot, virtual assistant, voice assistant, or the like that a user desires to interact.

References in this description to “an example”, “one example”, or the like, may mean that the particular feature, function, or characteristic being described is included in at least one example of the present invention. Occurrences of such phrases in this specification do not necessarily all refer to the same example, nor are they necessarily mutually exclusive.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

### Exemplary System Architecture

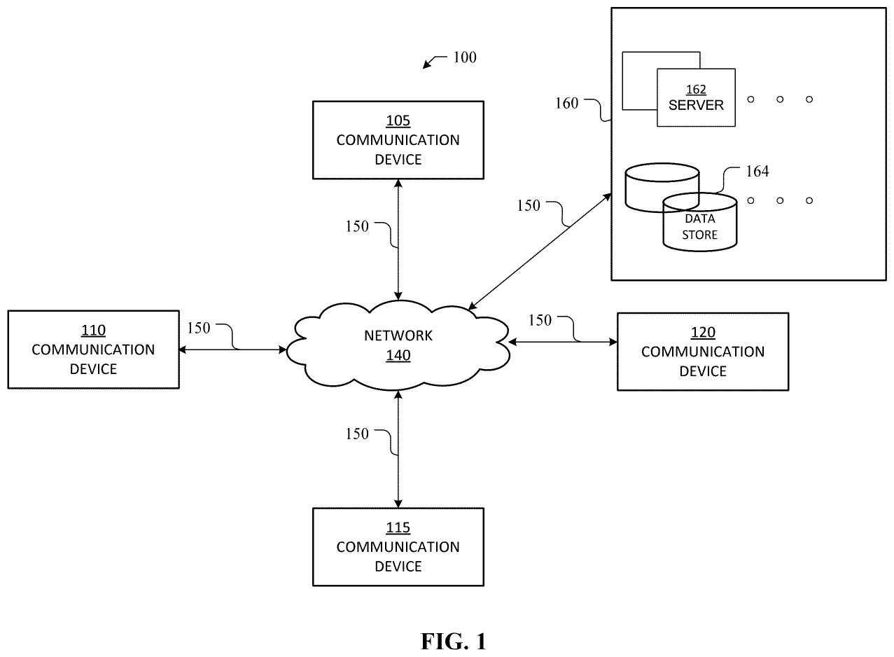

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented reality (AR)/virtual reality (VR) device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store several types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on several types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

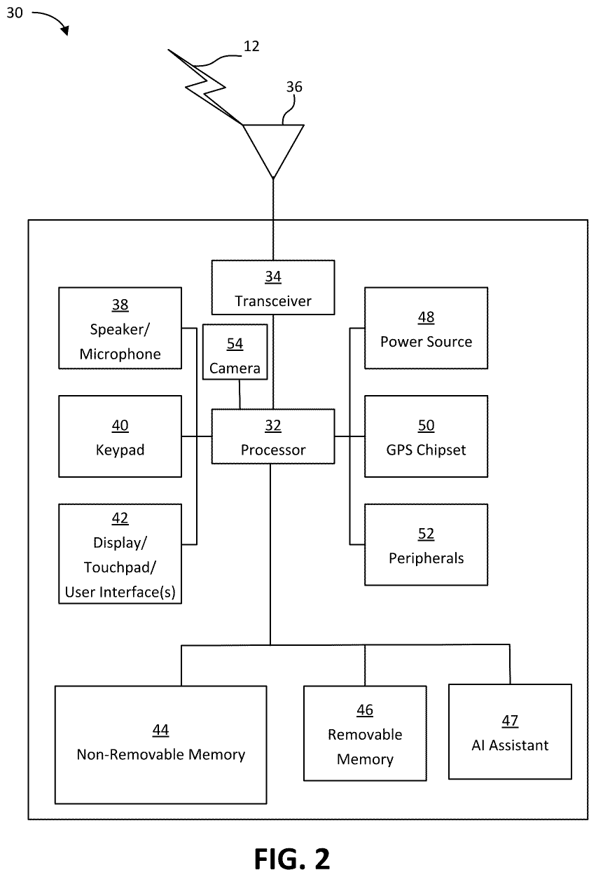

FIG. 2 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, a head-mounted display/device (e.g., a headset), smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or user interface(s) 42, a power source 48, a global positioning system (GPS) chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

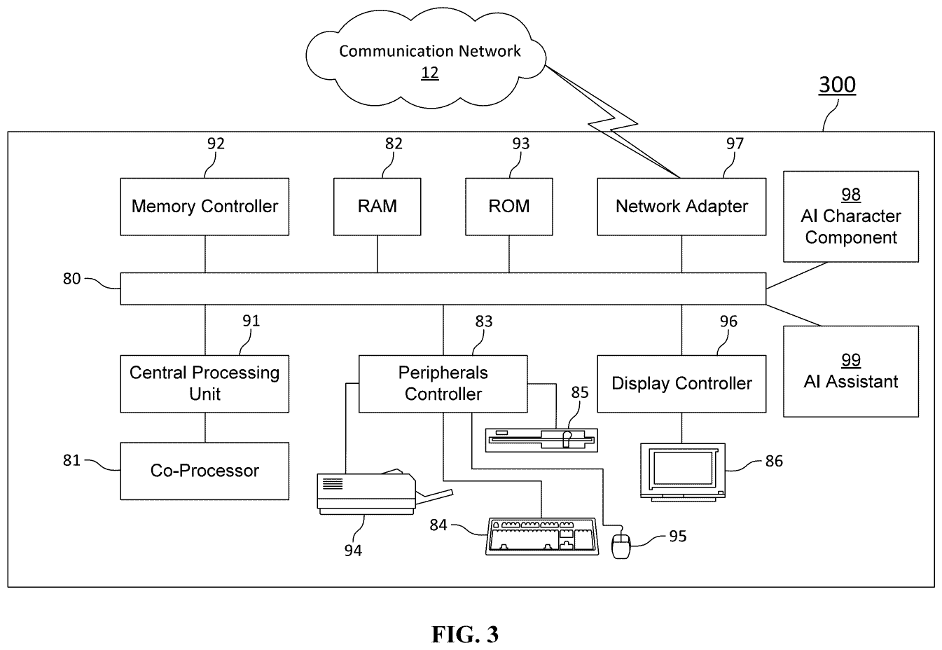

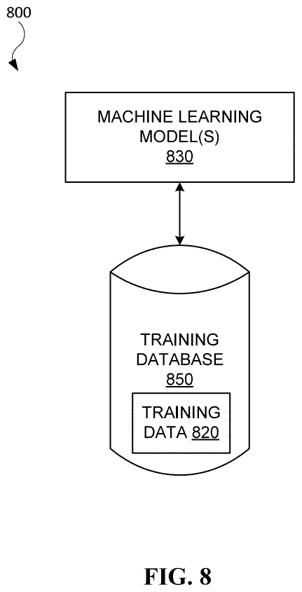

The UE 30 may further include an artificial intelligence (AI) Assistant 47 that may facilitate processing user requests, and accessing AI character components, which may be stored locally or remotely, as described more fully below. In some examples, at least one of the AI Assistant 47 and/or an AI character component (e.g., AI character Component 98 of FIG. 3) may implement a machine learning model (e.g., machine learning model(s) 830 of FIG. 8) and/or an AI model that may be pre-trained, trained in real-time, and/or periodically trained with training data (e.g., training data 820 of FIG. 8) to determine an intended character, personality, vocalization, and other interactive and conversational aspects.

### Exemplary Computing System

FIG. 3 is a block diagram of an exemplary computing system 300. In some exemplary embodiments, the network device 160 may be a computing system 300. The computing system 300 may include an AI Character Component 98, and an AI Assistant 99. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

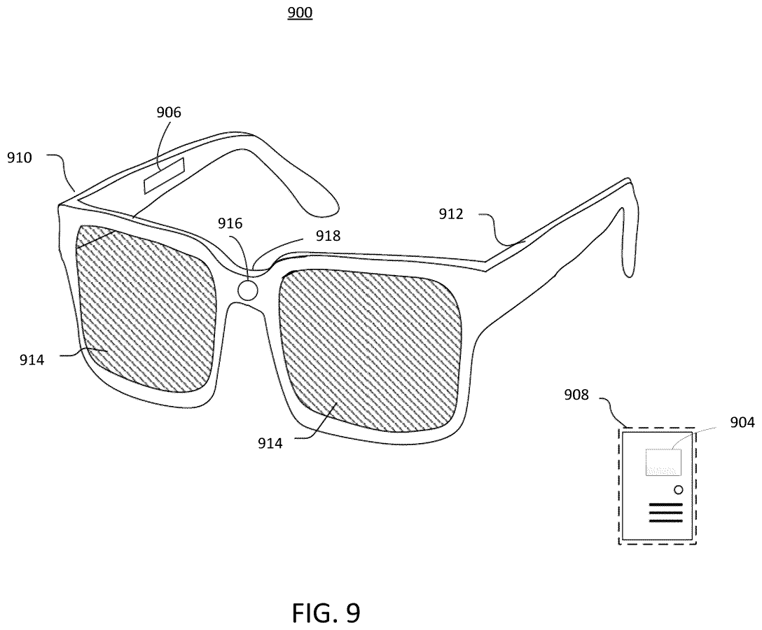

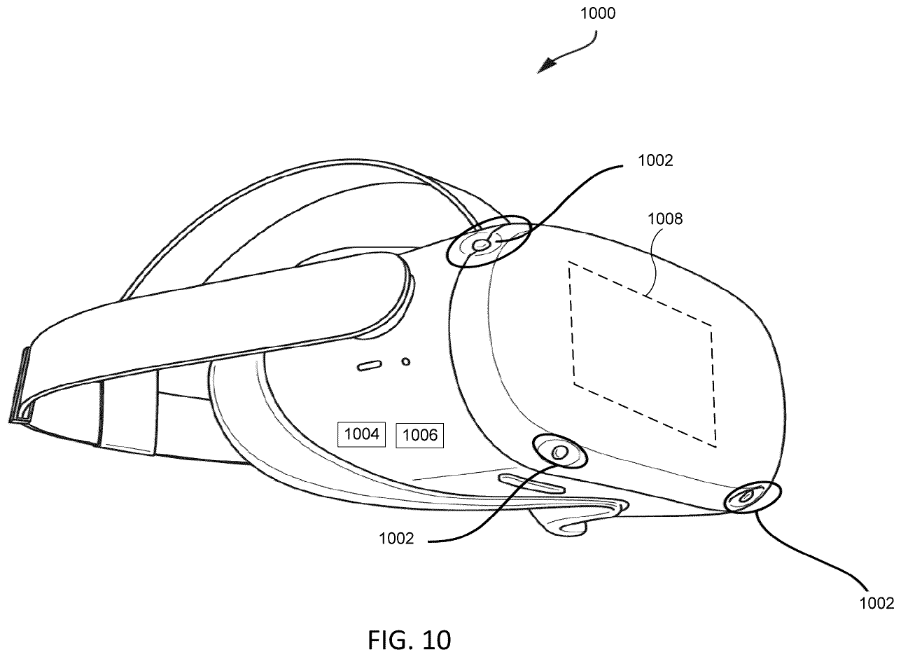

The AI Character Component 98 may receive one or more requests for content (e.g., response(s) to user input) from a device (e.g., from UE 30, head-mounted display (HMD) 910 of FIG. 9, and head-mounted display (HMD) 1000 of FIG. 10). In response to receipt of such a request(s) from the device, the AI Character Component 98 may generate one or more statements, questions, responses, images, videos and/or the like. In some examples, the AI Character Component 98 may facilitate provision of the generated one or more statements, questions, responses, images, videos and/or the like to the device (e.g., UE 30, HMD 900, HMD 1000). In some examples, the AI Character Component 98 may implement a machine learning model (e.g., machine learning model(s) 830 of FIG. 8) and/or an AI model that may be pre-trained, trained in real-time, and/or periodically trained with training data (e.g., training data 820 of FIG. 8) to generate the one or more statements, questions, responses, images, videos and/or the like. In some the examples, the AI Character Component 98 be configured to enable users to generate their own customized and personalized/tailored AI characters, as described more fully below.

The computer system 300 may also include an AI Assistant 99 that may facilitate processing user requests, and accessing AI character components, which may be stored locally (e.g., RAM 82, ROM 93) or remotely (e.g., non-removable memory 44, removable memory 46). In some examples, the AI Assistant 99 may be a type of base/primary AI agent/bot/chatbot, or the like that may receive queries and/or inquiries from user devices (e.g., UE 30, HMD 900, HMD 1000) of users and may provide responses to the queries/inquiries of the users. The AI Assistant 99 may also access and determine answers to questions, queries, inquiries, or the like to provide to user devices of users in instances in which a question, query, inquiry, or the like may be presented to an AI Character by a user but in which the AI Character may lack the information to provide a robust answer/response to the user device associated with the user asking the question(s), query, or inquiry. In some examples, the AI Assistant 99 may also implement a machine learning model (e.g., machine learning model(s) 830 of FIG. 8) to perform the functions and/or operations of the AI Assistant 99. In some examples, the AI Characters may, but need not, be subset AI agents/bots/chatbots, or the like to the AI Assistant 99, which may be a main/primary AI agent(s)/bot(s)/chatbot(s).

### Exemplary System Operation

Aspects of the present disclosure may relate to innovative methodologies for delivering AI Characters across platforms, including AR, VR, and MR environments, such as smart glasses. Aspects of the present disclosure may enable users to interact with AI characters using two distinct affordances. First, users may access AI Characters directly through a custom wake word that corresponds with the Character's name, facilitating personalized interactions using a unique Text-to-Speech (TTS) voice and specialized personality and knowledge. Second, users may initiate a multi-turn conversational session by asking a question and/or requesting an AI assistant, base model, or the like, to act as a concierge and connect them to the desired AI Character. Such approaches may allow for both frequent direct interactions with select AI Characters and occasional specialized queries to multiple other characters.

In examples, the AI Character model architecture may include several features working in tandem to deliver a seamless and immersive user experience. In examples, an AI Assistant model (e.g., AI Assistant 47, AI system 415, etc.) may communicate with one or more AI Character models (e.g., AI character 425), to deliver a real-time conversational experience to a user (e.g., user 405).

The AI Assistant (e.g., AI Assistant 47, AI system 415, etc.) may serve as a neutral, brand-aligned persona with large language model (LLM) and knowledge graph (KG) capabilities. It may provide information or take action based on user intent. The AI Assistant may serve as the primary interface through which users (e.g., user 405) can access various AI Characters.

AI Characters (see, e.g., AI Character 425) are specialized personas created using the LLM (e.g., machine learning model(s) 830). These characters are fine-tuned and prompt-engineered versions of the base LLM, each with its own unique Text-to-Speech (TTS) voice, personality, and knowledge base. Unlike the AI Assistant (e.g., AI Assistant 47), AI Characters are highly domain-specific and exhibit distinct behaviors and responses to the same query.

AI Characters encompass all character and personality entities that users may interact with, including any third-party character agents that may be integrated. AI Characters may provide a high-fidelity experience, including dynamic wake words, natural TTS voices, and personalized response content.

Dynamic wake words may enable users to select from a large set of wake words corresponding to different AI Characters. This feature allows for personalized and intuitive interactions. For example, a user may utter “OK AI” or “[AI Name]” or another custom word or phrase to initiate the AI Assistant and/or AI Character.

In numerous examples, AI Characters contain unique voices, which may utilize TTS technology. In examples, voices for AI Characters may be developed in batches, with a focus on increasing naturalness, distinctiveness, and personality for each character. This helps ensures that every AI Character has a unique and recognizable voice and may further enhance user immersion. Response content for AI Characters may include diction, elocution, personality, and unique perspectives. This content may be tailored to each character, to help ensure that interactions are consistent with the character's persona.

Various embodiments may include audio, image, and/or video representations of an AI Character in various environments, such as AR and VR environments including, but not limited to, headsets or other wearables, phones, tablets, laptops, applications operating on computing devices and the like. The AI Character model may support a wide range of platforms, environments, and uses cases across various domains.

### AI Assistant Invocation

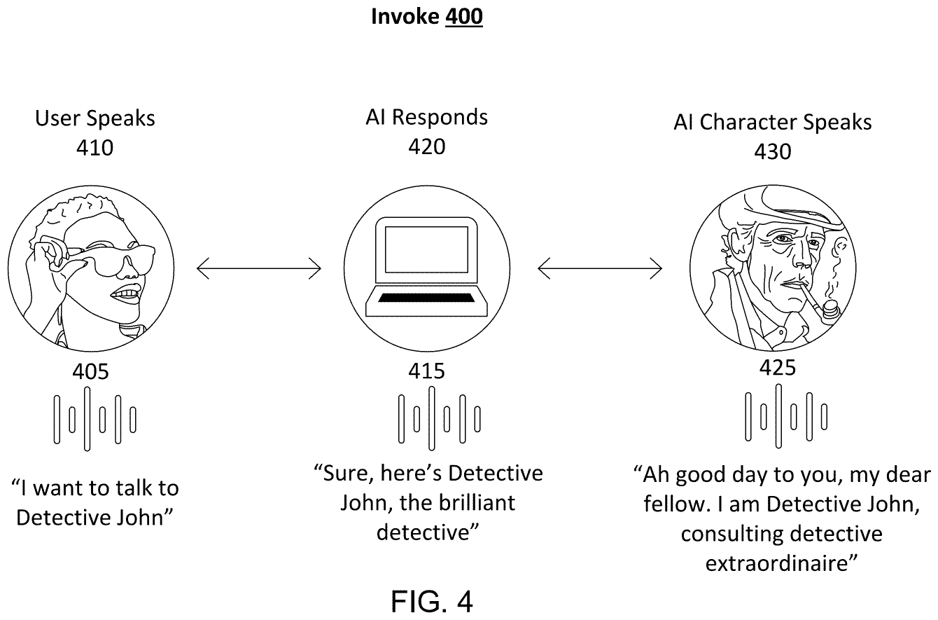

FIG. 4 illustrates an example to invoke 400 a character, in accordance with aspects discussed herein. In the illustrated example, a user 405 may initiate an interactive session by directly addressing the AI Assistant 415. The user may make a statement requesting a particular character, e.g., “I want to talk to Detective John.” In some examples, a wake word may be used (“Ok, AI Assistant”), a button may be pressed, or other gesture or action may be taken to initiate the AI Assistant. In the example of FIG. 4, Detective John is a fictitious character for purposes of illustration, and not of limitation.

The AI Assistant 415 may then respond 420 and connect the user 415 to the desired AI Character 425, allowing for a multi-turn conversational session. In some examples, the AI Assistant may respond with speech, e.g., “Sure here's Detective John, the brilliant detective.” Then the AI Character 425 may speak 430 and directly interact with the user 405. In numerous examples, each available AI Character may have its own custom TTS voice, providing a unique and immersive experience.

### AI Character Dismissal

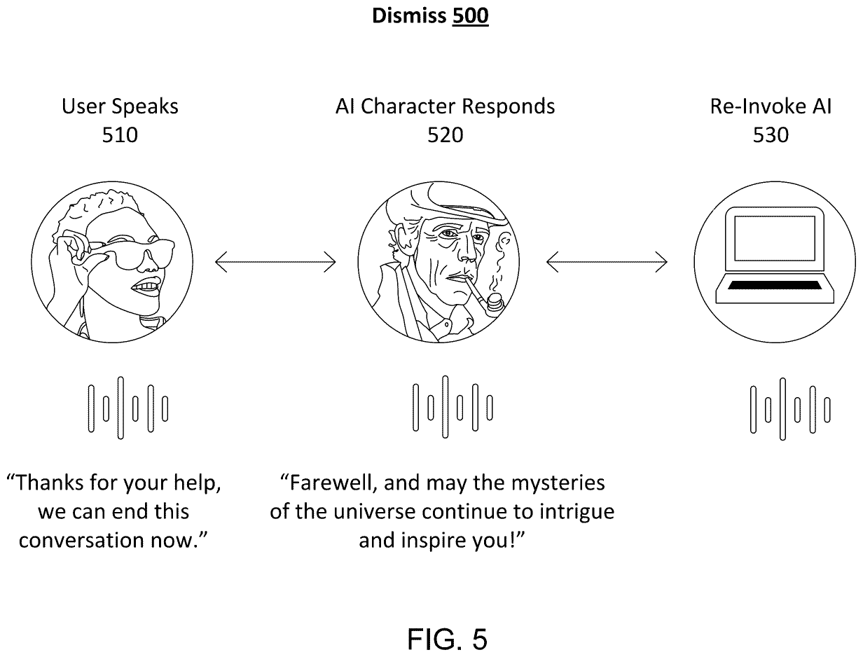

FIG. 5 illustrates an example to dismiss 500 an AI character, in accordance with aspects discussed herein. In the illustrated example, a user may be speaking to an AI Character during a session.

To dismiss the conversation the user speaks 510 to state their intent to end the conversation, e.g., “Thanks for your help, we can end this conversation now.” Any combination of words, phrases, or custom words, phrases, actions, and the like may be used to indicate a desire to end the session.

The AI Character responds 520 to acknowledge the dismissal, and the session may end. In some examples, this switches the AI Character model back to the AI Assistant model, such that the next interaction the user has with the device may be with the AI Assistant. As such, in order to initiate a new session with an AI Character, the user will re-invoke the AI 530, in accordance with various aspects discussed herein (see, e.g., FIG. 4).

### AI Character Conversation

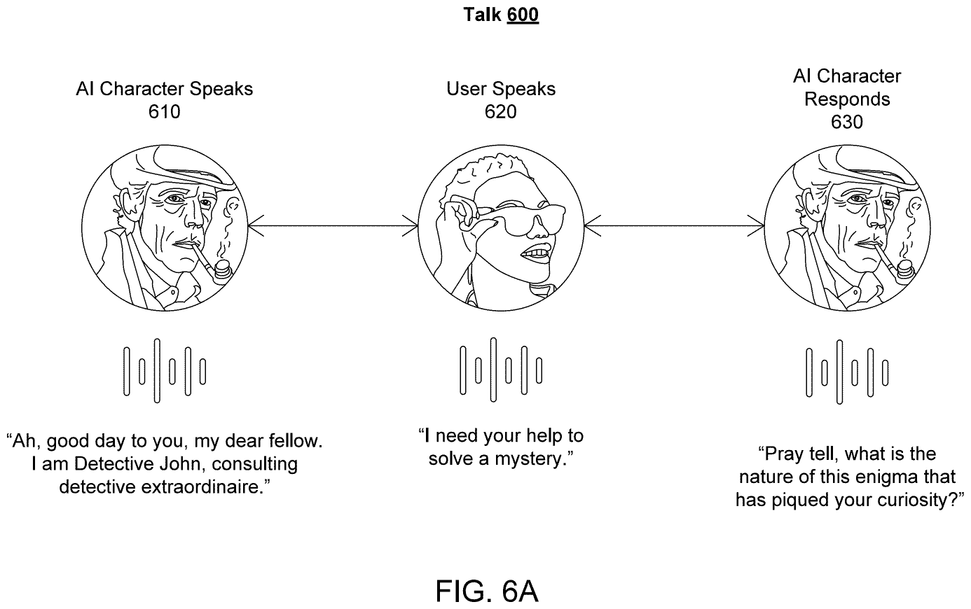

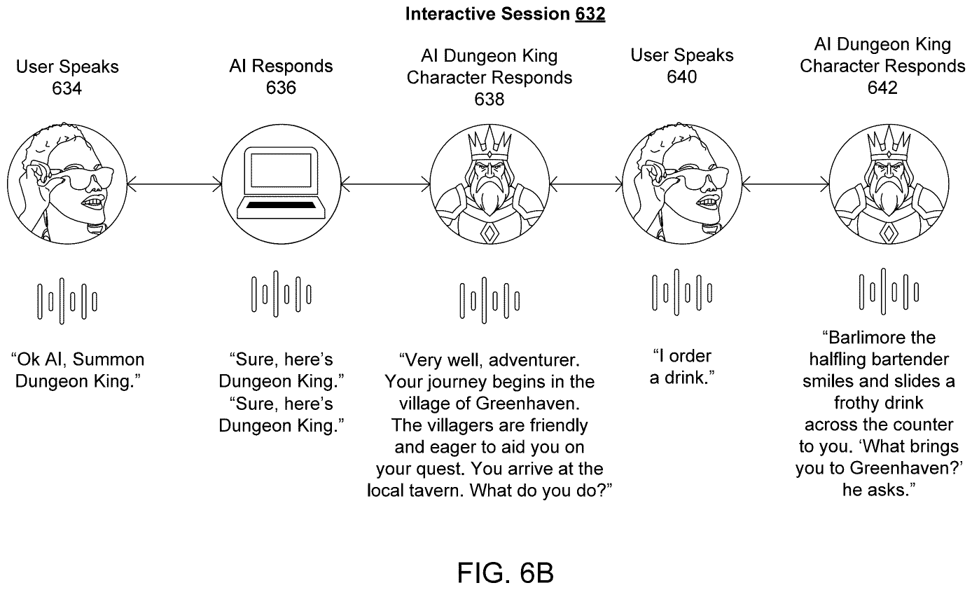

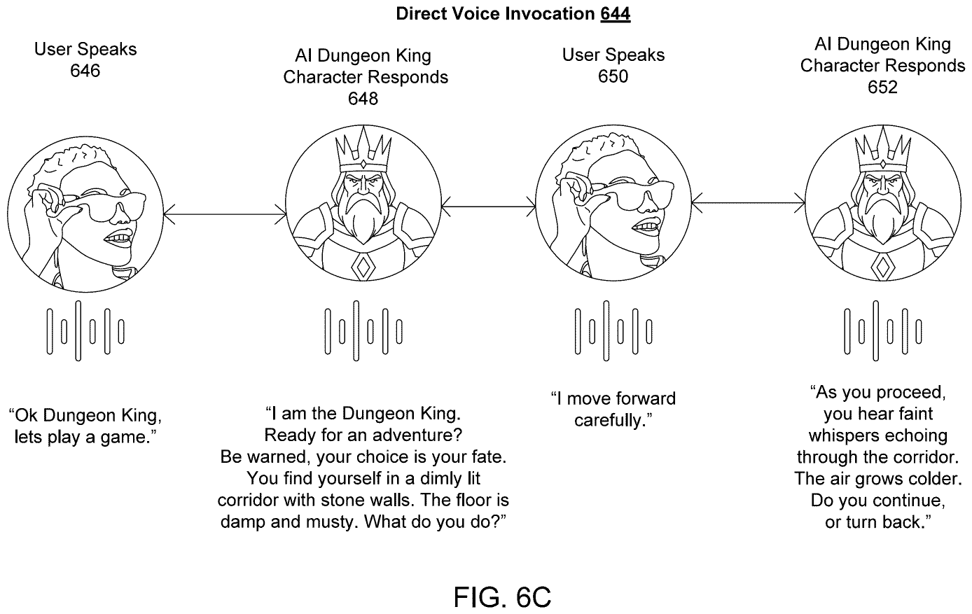

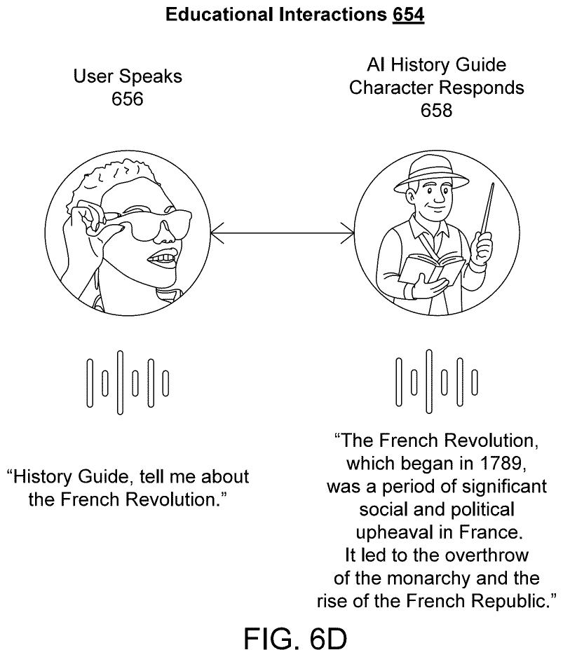

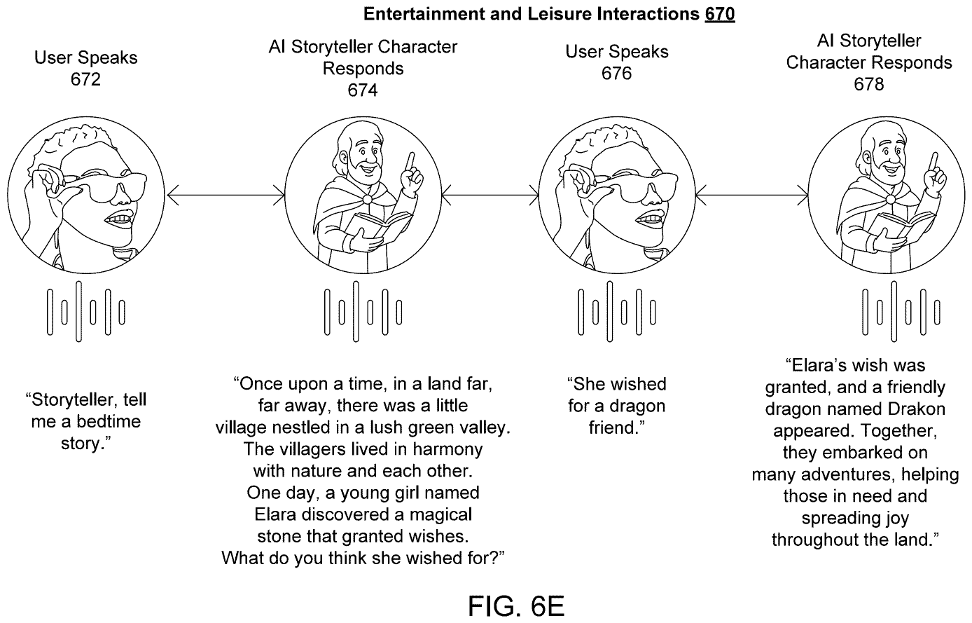

FIG. 6A illustrates an example conversation with an AI Character. Such interactions may indicate a scenario in which a user talks 600 to an AI Character and has an interactive conversation with the AI Character model. The AI Character model may be an AI Character Component which may be generated by the AI Character Component 98 of FIG. 3.

In such examples, the AI Character Speaks 610, making a statement or question to the user. The user speaks 620 in response, with a question, statement, or other query. The user's statement is processed, and the AI Character Responds 630 with a newly generated statement relevant to the user's response.

The following use cases provide numerous examples of interactions with an AI Character model, in accordance with various embodiments.

### Use Case Example 1: Interactive Session 632

FIG. 6B illustrates an interactive session with an AI Character(s) and an AI Assistant. In this example, a user may initiate an interactive session by directly addressing an AI Character or using an AI assistant. The AI assistant connects the user to the desired AI Character, allowing for a multi-turn conversational session. Each available character may have its own custom TTS voice, providing a unique and immersive experience. In the exemplary aspects of the present disclosure, Dungeon King denotes a fictitious character for purposes of illustration, and not of limitation. User: “Ok AI, Summon Dungeon Master.” (Step 634).
AI (Assistant): “Sure, Here's Dungeon Master.” (Step 636).
AI (Dungeon Master): “Very well, adventurer. Your journey begins in the village of Greenhaven. The villagers are friendly and eager to aid you on your quest. You arrive at the local tavern. What do you do?” (Step 638).
User: “I order a drink.” (Step 640).
AI (Dungeon Master): “Barlimore the halfling bartender smiles and slides a frothy drink across the counter to you. ‘What brings you to Greenhaven?’ he asks.” (Step 642).

### Use Case Example 2: Direct Voice Invocation 644

In this scenario of FIG. 6C, the user may directly address the AI Character, bypassing the AI assistant. This approach may be simple and intuitive, allowing for immediate and direct interactions with the AI Character. In this example, Dungeon King denotes a fictitious character.
User: “Ok, Dungeon King, let's play a game.” (Step 646).
AI (Dungeon King): “I am the Dungeon King. Ready for an adventure? Be warned, your choice is your fate. You find yourself in a dimly lit corridor with stone walls. The floor is damp and musty. What do you do?” (Step 648).
User: “I move forward carefully.” (Step 650).
AI (Dungeon King): “As you proceed, you hear faint whispers echoing through the corridor. The air grows colder. Do you continue, or turn back?” (Step 652).

### Use Case Example 3: Educational Interactions 654

In example of FIG. 6D, AI Characters may also be used in educational settings to provide interactive learning experiences. For example, a history AI Character may guide students, or other users, through historical events, providing detailed explanations and answering questions.
User: “History Guide, tell me about the French Revolution.” (Step 656).
AI (History Guide): “The French Revolution, which began in 1789, was a period of significant social and political upheaval in France. It led to the overthrow of the monarchy and the rise of the French Republic. (Step 658).

### Use Case Example 4: Entertainment and Leisure 670

FIG. 6E illustrates that AI Characters may provide entertainment and leisure activities, such as storytelling, game mastering, and role-playing. For instance, an AI Character designed as a storyteller or a particular character from a story could narrate tales. In another example, a game master character could lead users through complex scenarios in role-playing games.
User: “Storyteller, tell me a bedtime story.” (Step 672).
AI (Storyteller): “Once upon a time, in a land far, far away, there was a little village nestled in a lush green valley. The villagers lived in harmony with nature and each other. One day, a young girl named Elara discovered a magical stone that granted wishes. What do you think she wished for?” (Step 674).
User: “She wished for a dragon friend.” (Step 676).
AI (Storyteller): “Elara's wish was granted, and a friendly dragon named Drakon appeared. Together, they embarked on many adventures, helping those in need and spreading joy throughout the land.” (Step 678).

Accordingly, FIGS. 4, 5, 6A, 6B, 6C, 6D, and 6E illustrate numerous examples in which a user may interact with an AI Character model. Such techniques may be tailored, for example, based on user preference and the capabilities of the devices with which the AI Character model may be accessed.

In some examples, voice commands may be a primary method of interaction, allowing users to directly address AI Characters and/or the AI Assistant that may access the AI Character. In other examples, other commands (e.g., text based commands/instructions, selection of content from fields of user interfaces) may be utilized as a technique to facilitate interaction, allowing users to directly address AI Characters and/or the AI Assistant that may access the AI Character. In some examples of instances in which the other commands may be, for example, text based, the text based commands may be converted to audio (e.g., speech data) by a TTS technique. As discussed herein, dynamic wake words may enable personalized and intuitive interactions to access the AI Assistant, AI Character or other features. In some examples, the voice commands may be captured by a head-mounted display (e.g., HMD 914, HMD 1000). In other examples, the voice commands may be captured/detected by other communication devices (e.g., UE 30, a smart watch, etc.).

In some examples, gesture recognition technology may allow users to initiate interactions through physical gestures, such as waving, pointing, performing a different gesture, or pressing a button. The gesture method may be particularly useful in AR and VR environments, where hands-free interaction is convenient, beneficial, and/or essential.

In additional examples, users may also interact with the AI Assistant and AI Characters through text input, using devices such as smartphones, tablets, keyboards, or computers. This interaction method may provide an alternative for users who are unable to use voice commands, are in noisy environments, or prefer not to use voice commands.

In the numerous examples discussed herein, AI Character interaction techniques may support multi-device access, enabling users to interact with AI agents across various devices, including but not limited headsets, tablets, phones, video game consoles, and applications. This may ensure a consistent and seamless user experience, regardless of the device being used.

The AI Character systems and methods described herein may offer a robust and versatile framework for enhancing user interactions across multiple platforms. By integrating advanced machine learning techniques, dynamic wake words, natural TTS voices, and personalized response content, the architecture provides a unique and immersive experience for users. The various use cases and interaction methods demonstrate the flexibility and applicability of the system, making it a valuable tool for a wide range of applications.

In some exemplary aspects of the present disclosure, the AI Characters may be capable of having access to the same knowledge that a main AI Assistant (e.g., AI system 415) may have and may perform the same type of query assessments and responses to a user(s) that a main AI assistant may also perform.

In some other examples of the present disclosure, the AI Characters may operate in the context and/or genre of their character(s). As such, for purposes of illustration and not of limitation, for example, in an instance in which an AI Character is associated with a medieval character, and receives a query from a user for a recipe, the AI Character associated with the medieval character may provide the user a recipe for shepherd's pie and/or a medieval bar drink since the medieval genre is the context/space that this AI Character is operating/functioning within.

In some examples, in an instance in which a user makes a query that is determined to be outside of the context/genre of the AI Character, for example, the medieval style/theme character above, the AI Character may handle this situation in two diverse ways. In one approach, the AI Character may automatically provide (e.g., an automatic handoff of the query) the user's query that is outside the medieval context/genre to the main AI Assistant (e.g., AI system 415) and the main AI Assistant may respond with an answer in reply to the query to the user.

For example, if the user's query is “what is the weather forecast today,” the AI Character may provide this query regarding the weather to the main AI Assistant and the main AI Assistant may provide the weather forecast to the user (e.g., via a communication device of the user).

In another approach, even in an instance in which the AI Character may determine that a user's query is outside of the context/genre of the AI Character (e.g. outside of the medieval context), the AI Character may still continue the interactions with the user. In this regard, for example, the AI Character may inform the user that the AI Character is obtaining the answer to the user's query from the main AI Assistant (e.g., AI system 415). Upon detection, or receipt, by the AI Character of the answer from the AI Assistant, the AI Character may provide the answer to the user. For instance, in the example above pertaining to “what is the weather forecast today,” the AI Character may detect and obtain today's weather forecast from the main AI Assistant and the AI Character may provide (e.g., as an audio output, etc.) today's weather forecast to the user.

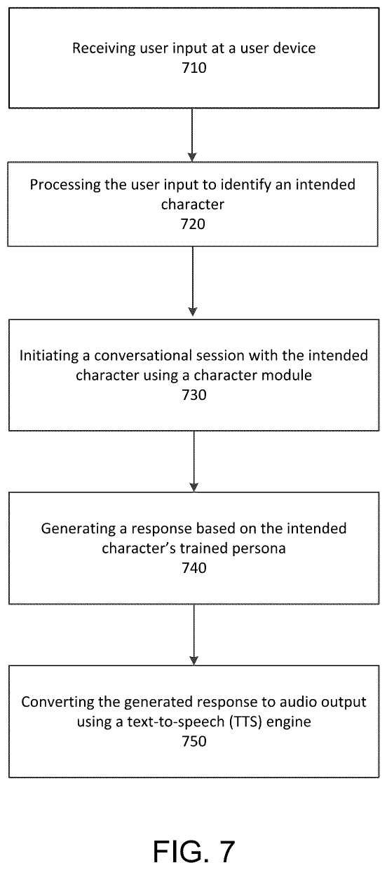

FIG. 7 illustrates a flowchart for facilitating character-based user engagement in accordance with examples of the present disclosure. At block 710, a device (e.g., augmented reality system 900 of FIG. 9) may receive user input at a user device. The user input may include at least one of a text prompt or an audio prompt. The user input may be received via a user interface (e.g., display/touchpad/user interface 42). The user device may include at least one of a headset, smartphone, tablet, laptop, or gaming console. In examples, the user interface may include an input field for receiving the text prompt and/or an audio input component for receiving the audio prompt. In some examples, the user input may be captured by a speaker/microphone (e.g., speaker/microphone 38). In another example, the user input may include an audio prompt, and the device may convert the audio prompt to a text format using an automatic speech recognition (ASR) system. The text format may also be processed, for example, by a large language model to generate a mapping to an embedding space.

At block 720, a device (e.g., augmented reality system 900) may process the user input to identify an intended character. Processing the user input may include recognizing at least one dynamic wake word to initiate an interaction with an AI Assistant component, an AI character component, and a request to access an AI character component.

At block 730, a device (e.g., augmented reality system 900) may initiate a conversational session with the intended character using a character component. In examples the AI assistant accesses the character component, which may be stored locally on the device or stored remotely, e.g., at a remote database accessible via wireless network communication.

At block 740, a device (e.g., augmented reality system 900) may generate a response, by the character component, based on the intended character's trained persona. The character component may process the user input, as discussed above, to generate the response. In examples, the response may be answer to a question asked by the user. In other examples, the response may be a standard opening phrase, question, or statement, based on the intended character's trained persona. In examples, the trained persona may be trained on one or more text, image, and audio input relevant to the character. A character, for example, may be trained on text, dialogue, illustrations, and other media related to the character. An AI Character Component may, for example, be fine-tuned and prompt-engineered from a base LLM (e.g., machine learning model(s) 830).

At block 750, a device (e.g., augmented reality system 900) may convert the generated response to audio output using a Text-to-Speech (TTS) engine. The audio output may be provided on the device via a speaker (e.g., speaker/microphone 38).

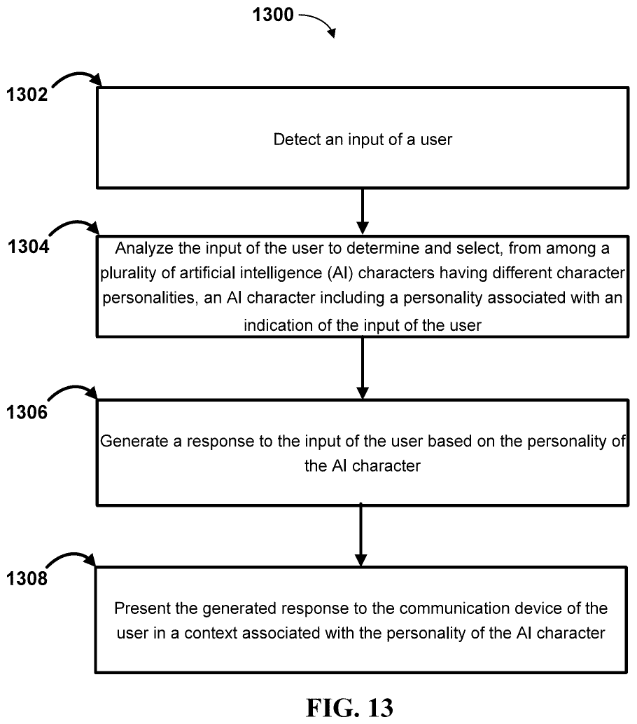

FIG. 8 illustrates an example of a machine learning framework 800 including machine learning model(s) 830 and a training database 850, in accordance with one or more examples of the present disclosure. The training database 850 may store training data 820. In some examples, the machine learning framework 800 may be hosted locally in a computing device or hosted remotely. By utilizing the training data 820 of the training database 850, the machine learning framework 800 may train the machine learning model(s) 830 to perform one or more functions, described herein, of the machine learning model(s) 830. In some examples, the machine learning model(s) 830 may be stored in a computing device. For example, the machine learning model(s) 830 may be embodied within a communication device (e.g., UE 30). In some other examples, the machine learning model(s) 830 may be embodied within another device (e.g., computing system 300). Additionally, the machine learning model(s) 830 may be processed by one or more processors (e.g., processor 32 of FIG. 2, coprocessor 81 of FIG. 3, controller 904 of FIG. 9, processor 1004 of FIG. 10). In some examples, the machine learning model(s) 830 may be associated with operations (or performing operations) of FIG. 7 and/or FIG. 13. In some other examples, the machine learning model(s) 830 may be associated with other operations. In some examples, the machine learning model(s) 830 may be an example of the AI Assistant 47, the AI Character Component 98 and/or the AI Assistant 99.

The training data 820 employed by the machine learning model(s) 830 may be pre-trained, fixed or updated periodically. Alternatively, the training data 820 may be updated in real-time based upon the evaluations performed by the machine learning model(s) 830 in a non-training mode. This may be illustrated by the double-sided arrow connecting the machine learning model(s) 830 and stored training data 820 which may be stored in the training database 850. Some other examples of the training data 820 may include, but are not limited to, items of content determined as being associated with a network (e.g., the Internet, a social network, etc.), a platform (e.g., system 100), or the like. Other examples of training data 820 for the machine learning model(s) 830 may be detected/captured personalities, traits, attributes, behaviors, and personas of various characters and voices, types of voices of characters accessible from publicly available data/content (e.g., non-private) such as public network data (e.g., network 140), and other publicly available content such as books, articles, movies, animations, video clips and other content associated with characters. Additionally, training data 820 may include user designated (e.g., user defined data) associated with types of personalities, traits, behaviors, tones, styles and/or voices of various characters.

For purposes of illustration and not of limitation, for example, the training data 820 may relate to attributes of objects. For example, the object(s) may be characters, personalities, notable figures, and/or the like. The training data 820 may be utilized to train the machine learning model(s) 830 to predict/determine one or more character components and/or character responses based on an audio prompt(s) and/or text prompt(s) (e.g., “I want to talk to Detective John” of FIG. 4) of a device. The determined one or more character components and/or responses may be output by the machine learning model(s) 830, for example, via a user interface and/or a display. Additionally, as described above, the machine learning model(s) 830 may be trained at an initial stage, in real-time and/or trained periodically (e.g., updated periodically). In some example aspects, the training data 820 may be synthetically generated by an appropriately prompted/trained large language model (LLM). In some other example aspects, the training data 820 may be generated/created manually by one or more users (e.g., people/individuals).

In some examples, the machine learning model(s) 830 may evaluate attributes, such as for example text, dialogue, images, pictures, videos, character representations, variations, and/or the like. In some examples, the training data 820 used for the machine learning model(s) 830 may include, but is not limited to, historical records, recorded conversations, books, movie scripts, character biographies, literary works, voice recordings, and/or visual media related to a character(s) to generate an AI Character(s).

FIG. 9 illustrates an example augmented reality system 900. In some examples, the augmented reality system 900 may be an example of the head-mounted system 900. The augmented reality system 900 may include a head-mounted display (HMD) 910 (e.g., glasses) comprising a frame 912, one or more displays 914, and a computer 908 (also referred to herein as computing device 908). The displays 914 may be transparent or translucent allowing a user wearing the HMD 910 to look through the displays 914 to see the real world and displaying visual augmented reality content to the user at the same time. The HMD 910 may include an audio device 906 (e.g., speaker/microphone 38 of FIG. 2) that may provide audio augmented reality content to users. The HMD 910 may include one or more cameras 916, 918 which may capture images and/or videos of environments. The HMD 910 may include an eye tracking system to track the vergence movement of the user wearing the HMD 910. In one example embodiment, the HMD 910 may include a camera(s) 918 (also referred to herein as rear camera 918) which may be a rear-facing camera tracking movement and/or gaze of a user's eyes.

One of the cameras 916 (also referred to herein as front camera 916) may be a forward-facing camera capturing images and/or videos of the environment that a user wearing the HMD 910 may view. The HMD 910 may include an eye tracking system to track the vergence movement of the user wearing the HMD 910. In one example, the camera(s) 918 may be the eye tracking system. The HMD 910 may include a microphone of the audio device 906 to capture voice input from the user. The augmented reality system 900 may further include a controller 904 (e.g., processor 32 of FIG. 2) comprising a trackpad and one or more buttons. The controller 904 may receive inputs from users and relay the inputs to the computing device 908. The controller 904 may also provide haptic feedback to users. The computing device 908 may be connected to the HMD 910 and the controller 904 through cables and/or wireless connections. The computing device 908 may control the HMD 910 and the controller 904 to provide the augmented reality content to and receive inputs from one or more users. In some example embodiments, the controller 904 may be a standalone controller or integrated within the HMD 910. The computing device 908 may be a standalone host computer device, an on-board computer device integrated with the HMD 910, a mobile device, or any other hardware platform capable of providing augmented reality content to and receiving inputs from users. In some examples, HMD 910 may include an augmented reality system/virtual reality system (e.g., artificial reality system).

### Exemplary Artificial Reality System

FIG. 10 illustrates an example of an artificial reality system including a head-mounted display (HMD) 1000, image sensors 1002 mounted to (e.g., extending from) HMD 1000, according to at least one example aspect of the present disclosure. In some examples of the present disclosure, the HMD 1000 may be an example of artificial reality system 1000 and/or HMD 1010. In some example aspects, image sensors 1002 may be mounted on and protruding from a surface (e.g., a front surface, a corner surface, etc.) of HMD 1000. In some exemplary aspects, HMD 1000 may include an artificial reality system/virtual reality system. In an exemplary aspect, image sensors 1002 may include, but are not limited to, one or more sensors (e.g., cameras 916, 918, a display 914, an audio device 906, etc.), a memory 1006 (e.g., RAM, ROM) and a processor 1004 (e.g., a controller (e.g., controller 904)). In some example aspects, the processor 1004 may perform functions/operations as the functions/operations of the AI Assistant 47, the AI Character Component 98 and/or the AI Assistant 99. In exemplary aspects, a compressible shock absorbing device may be mounted on image sensors 1002. The shock absorbing device may be configured to substantially maintain the structural integrity of image sensors 1002 in case an impact force is imparted on image sensors 1002. In some exemplary embodiments, image sensors 1002 may protrude from a surface (e.g., the front surface) of HMD 1000 so as to increase a field of view of image sensors 1002. In some examples, image sensors 1002 may be pivotally and/or translationally mounted to HMD 1000 to pivot image sensors 1002 at a range of angles and/or to allow for translation in multiple directions, in response to an impact. For example, image sensors 1002 may protrude from the front surface of HMD 1000 so as to give image sensors 1002 at least a 180 degree field of view of objects (e.g., a hand, a user, a surrounding real-world environment, etc.).

The HMD 1000 may further include a display 1008 designed to present visual information based on an artificial reality system application(s) (e.g., VR) and/or AR application(s) as well as mixed reality application(s). Additionally or alternatively, the display 1008 may be coupled (e.g., electrically coupled) to each of the image sensors 1002, and may present visual information in the form of an external environment, as captured by one or more of the image sensors 1002. Using one or more of the image sensors 1002, the HMD 1000 may capture content and/or media in the environment and may present the content/media onto the display 1008.

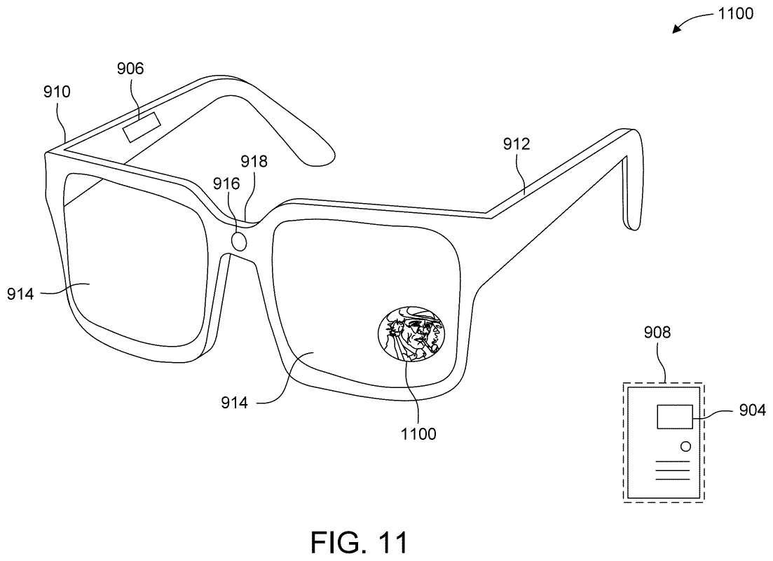

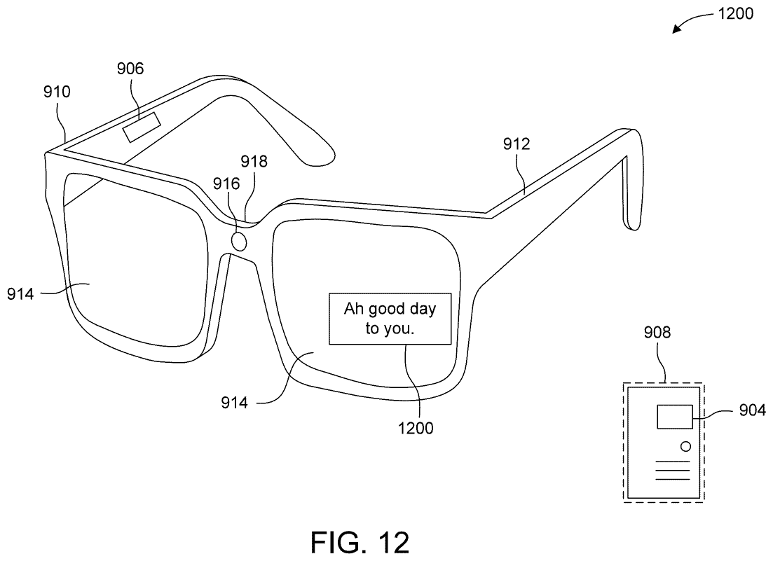

For purposes of illustration and not of limitation, in the examples of FIG. 9 and FIG. 10, a user may utilize headsets (e.g., HMD 1000), smart glasses (e.g., HMD 910), or the like to speak and interact with one or more AI Characters, AI Assistants and/or the like. In this regard, the image sensors 102 and/or audio device 906 may capture speech content (e.g., voice data of the user) and may perform an automatic speech recognition (ASR), and/or a speech-to-text (STT) function(s), to provide the AI Character(s) and/or the AI Assistant(s) data (e.g., text data based on the speech content) associated with the speech content. The controller 904 and/or the processor 1004 may be utilized to detect/capture spoken content (e.g., audio) by a user associated with, or indicating, features and/or attributes for a persona of an AI Character(s) such that the controller 904 and/or processor 1004 may create/generate the AI Character(s) for the user to interact with. In this regard, the controller 904 and/or the processor 1004 may generate one or more personalized and/or custom-tailored AI Characters for a user to interact with to provide queries to the AI Characters and to receive responses (e.g., answers) to the queries. The AI Characters may have a unique voice and/or features or attributes designated, or selected, by the user, for the persona of the generated AI Characters. The image sensors 1002 and/or the audio device 906 may output the responses to the queries as audio content to a user of (e.g., a user wearing) the HMD 910 or HMD 1000. In some examples, the controller 904 and/or the processor 1004 may output some content associated with the responses to the queries to a display (e.g., display 914, display 1008) of the HMD 910 and/or the HMD 1000. Some examples of the content that may, but need not, be output to the displays of the HMD may be text, an icon(s), a picture(s), an avatar(s), an image(s), a video(s), an animation(s), or other graphical element, or the like. For instance, in the example of FIG. 11, the controller 904 and/or the processor 1004 may output content to the display 914 such as, for example, an icon 1100 depicting the AI Character that a user may be engaging/interacting with (e.g., providing a query to and/or receiving a response to the query from the AI Character). As another example, in the example of FIG. 12, the controller 904 and/or the processor 1004 may output content to the display 914 such as, for example, a text 1200 response by an AI Character to a query by a user provided to the AI Character. In some examples, although the icon 1100 and the text 1200 appear forward facing to a direction of an environment (e.g., a real-world environment), the icon 1100 and the text 1200 may be presented inverted such that the icon 1100 and the text 1200 are viewable and legible to an eye of a user (e.g., a user wearing the HMD 910 or the HMD 1000) via the display (e.g., display 914, display 1008).

Additionally, in some exemplary aspects of the present disclosure, various AI Characters may be prestored, and/or provided (e.g., by computer system 300) in real time to memory devices of communication devices (e.g., UE 30, HMD 914, HMD 1000). Some examples of the memory devices may be, but are not limited to, non-removable memory 44, removable memory 46, RAM 82, ROM 93, memory 1006, a memory of computing device 908. These AI Characters may be different in that they may have their own unique associated (e.g., synthesized) voices and their own distinct personalities and personas. In some other example aspects, devices (e.g., speaker/microphone 38, audio device 906, image sensor(s) 1002) of the communication devices (e.g., UE 30, HMD 914, HMD 1000) may capture audio of a user speaking to make designations of attributes and/or features that the user desires for creation/generation of a new AI Character for interaction with the user. The user may also designate (e.g., by voice instruction/command or other input(s) (e.g., text input via a user interface)) whether the new AI Character may be utilized by other users for interaction with the other users. In this regard, for example, a user may utilize their voice to maneuver through audio questions generated by an AI Character Component (e.g., AI Character Component 98), and/or an AI Assistant (e.g., AI Assistant 47, AI Assistant 99), as prompts requesting audio answers from the user about the desired personality (e.g., detective, storytelling, historian, sports journalist, travel agent, etc.), desired voice, behavior, and/or traits (e.g., helpful, serious demeanor, funny, caring, professional, sarcastic, etc.) of the desired AI Character to establish/set the tone, and style of the AI Character. In this manner, the AI Character Component and/or the AI Assistant may detect/capture the inputs of the user's voice to the questions to generate the newly desired AI Character. As such, users may generate customized and tailored AI Characters that may be tailored to the personality/persona for the AI Character desired by the user(s).

In some other examples, the prompts generated by the AI Character Component and/or the AI Assistant may be provided/presented by an application (app) and a user may utilize the app to answer questions in response to the prompts to make the selections, via one or more user interfaces, to facilitate the creation/generation, by the AI Character Component and/or the AI Assistant, of the one or more newly desired AI Characters.

FIG. 13 illustrates an example flowchart process 1300 illustrating operations for facilitating AI Character based interactions according to an example of the present disclosure. At operation 1302, a device (e.g., computing system 300, UE 30, HMD 914, HMD 1000) may detect an input of a user. In some examples, the input of the user may be voice data spoken by a user. In other examples, the input of the user may be other data input (e.g., text data, selection of one or more items of data from a user interface). At operation 1304, a device (e.g., computing system 300, UE 30, HMD 914, HMD 1000) may analyze the input of the user to determine and select, from among a plurality of AI characters having different character personalities, an AI character including a personality associated with an indication of the input of the user.

At operation 1306, a device (e.g., computing system 300, UE 30, HMD 914, HMD 1000) may generate a response to the input of the user based on the personality of the AI character. At operation 1308, a device (e.g., computing system 300, UE 30, HMD 914, HMD 1000) may present the generated response to the communication device of the user in a context associated with the personality of the AI character.

Aspects of the present disclosure may include systems and methods for facilitating AI Character-based interactions on platforms such as, for example, wearable devices, virtual reality devices, and/or mixed reality devices. Aspects may receive user input at a user device, and process user input to identify an intended character. A conversational session with the intended character may be initiated and operated using a character component. One or more responses to a user query or statement may be made based on the intended character's trained persona. The generated response may be converted to audio output using a text-to-speech (TTS) engine.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
detecting, by a communication device, an input of a user;
analyzing the input of the user to determine and select, from among a plurality of artificial intelligence (AI) characters comprising distinctive character personalities, an AI character comprising a personality associated with an indication of the input of the user;
generating a response to the input of the user based on the personality of the AI character; and
presenting the generated response to the communication device of the user in a context associated with the personality of the AI character.

2. The method of claim 1, wherein the input of the user comprises voice data spoken by the user.

3. The method of claim 1, wherein:
presenting the generated response further comprises outputting, by the communication device, the generated response as audio content.

4. The method of claim 1, wherein the communication device comprises smart glasses or a head-mounted display device.

5. The method of claim 1, further comprising:
analyzing detections of items of voice data by the user to generate a new AI character comprising a different personality in relation to the personalities of the plurality of AI characters.

6. The method of claim 1, further comprising:
outputting, by a display device of the communication device, a subset of the content associated with the generated response.

7. The method of claim 6, wherein the display device comprises a display of smart glasses or a display of a head-mounted display device.

8. The method of claim 7, wherein the subset of the content comprises one or more of text data, an image, an avatar of the AI character, or a video associated with the generated response in reply to the input of the user.

9. The method of claim 1, further comprising:
outputting the generated response in a synthesized voice associated with the personality assigned to the AI character.

10. The method of claim 1, wherein:
generating the response further comprises generating the response to the input of the user by implementing a machine learning model associated with training data comprising traits, behaviors, and a synthesized voice of the personality of the AI character.

11. The method of claim 1, wherein the input of the user and the generated response comprises an interactive conversation between the user and the AI character.

12. An apparatus comprising:
one or more processors; and
at least one memory storing instructions, that when executed by the one or more processors, cause the apparatus to:
detect, by the apparatus, an input of a user;
analyze the input of the user to determine and select, from among a plurality of artificial intelligence (AI) characters comprising distinctive character personalities, an AI character comprising a personality associated with an indication of the input of the user;
generate a response to the input of the user based on the personality of the AI character; and
present the generated response to a communication device of the user in a context associated with the personality of the AI character.

13. The apparatus of claim 12, wherein the input of the user comprises voice data spoken by the user.

14. The apparatus of claim 12, wherein when the one or more processors further execute the instructions, the apparatus is configured to:
present the generated response by outputting, by the apparatus, the generated response as audio content.

15. The apparatus of claim 12, wherein the apparatus comprises smart glasses or a head-mounted display device.

16. The apparatus of claim 12, wherein when the one or more processors further execute the instructions, the apparatus is configured to:
analyze detections of items of voice data by the user to generate a new AI character comprising a different personality in relation to the personalities of the plurality of AI characters.

17. The apparatus of claim 12, wherein when the one or more processors further execute the instructions, the apparatus is configured to:
output, by a display device of the apparatus, a subset of the content associated with the generated response.

18. The apparatus of claim 12, wherein when the one or more processors further execute the instructions, the apparatus is configured to:
output the generated response in a synthesized voice associated with the personality assigned to the AI character.

19. A non-transitory computer-readable medium storing instructions that, when executed, cause:
detecting, by a communication device, an input of a user;
analyzing the input of the user to determine and select, from among a plurality of artificial intelligence (AI) characters comprising distinctive character personalities, an AI character comprising a personality associated with an indication of the input of the user;
generating a response to the input of the user based on the personality of the AI character; and
presenting the generated response to the communication device of the user in a context associated with the personality of the AI character.

20. The computer-readable medium of claim 19, wherein the instructions, when executed, further cause:
presenting the generated response by outputting, by the communication device, the generated response as audio content.
